(19) United States
(12) Patent Application Publication
(10) Pub. No.: US 2004/0054037 A1
(43) Pub. Date: Mar. 18, 2004

(54) Paper coating composition

(76) Inventors: Henk J.F. Abbeele van den, Schaffen Diest (BE); Erik M.J. Jonsson, Herentals (BE)

Correspondence Address: Pillsbury Winthrop, Intellectual Property Group, 1600 Tysons Boulevard, McLean, VA, 22102, US

(21) Appl. No.: 10/450,026

(22) PCT Filed: Dec. 10, 2001
(86) PCT No.: PCT/NL01/00895

(30) Foreign Application Priority Data
Dec. 11, 2000 (NL) 1016845

(51) Int. Cl. C08K 3/00

(52) U.S. Cl. 524/47; 524/599

(57) ABSTRACT

The invention relates to an aqueous paper coating composition. Such a composition, applied to paper, is suitable in particular for printing of the paper. The paper coating composition contains between 0.01 and 100 wt. % of a highly branched polyester amide. The invention also relates to a process for the preparation of a composition according to the invention that also contains SMA in which an aqueous solution of SMA and a highly branched polyester amide is heated to at least 50° C. The invention further relates to paper coated with a composition according to the invention.

The invention relates to an aqueous paper coating composition containing water and a solid with a solid content of between 1 and 75 wt % relative to the weight of water and solid. Such a composition, applied to paper, is suitable in particular for printing of the paper. Where this invention refers to paper, this shall be understood to include cardboard and printable film.

Paper coating compositions are known from Encydopedia Chemical Technology 4^{th} Ed., Vol 18, pp. 35-60, 1996 (ISBN 0-471-52687-9). According to this publication, conventional paper has a rough surface, making it less suitable for high-speed printing. In addition, quality printing sometimes requires a high gloss or in other cases, conversely, a mat surface in both printed and unprinted parts of the paper. This is the reason why much paper is provided with a coating. The principal properties of a printable paper coating are not only a smooth or a mat surface, but also a high ink absorption rate and good resolution of printed matter produced using the paper. Furthermore, the paper's surface strength should be high enough to avoid cracking as a result of high paper tensions in a high-speed printing process.

Paper coating compositions are generally aqueous slurries with a solid content of between 1 and 75 wt. %. As a rule they also contain a pigment, binders and other additives. In many cases the composition contains an ammonium salt to neutralize the solution.

Paper coating compositions are generally applied to the paper by means of a coating knife. For this process to proceed as desired, a certain viscosity of the composition is needed. A too high viscosity leads to high shearing forces under the coating knife as a result of dilatiant behaviour, thus reducing the rate at which the composition can be applied. A too low viscosity, caused by a too high water content, slows down the process due to longer drying times. When a low viscosity is created by adding low-molecular compounds that remain present in the paper coating, this generally has an adverse effect on the properties of the paper coating.

The object of the invention is to provide a coating composition that has a low viscosity without this affecting the properties of the paper coating composition after application to paper.

This object is achieved in that the paper coating composition contains between 0.01 and 100 wt. % (relative to the solid weight) of a highly branched polyester amide.

This ensures that the paper coating composition has a substantially lower viscosity without properties such as ink absorption rate, resolution and surface strength of the coating composition applied to paper being reduced.

A highly branched polyester amide, hereinafter also called a Hybrane^{R}, is understood to be a linear or branched condensation polymer containing ester groups and at least an amide group in the backbone and having a number average molar mass of at least 800 g/mol. Preferably the highly branched polyester amide has a molar mass of between 800 and 15,000 g/mol. Preferably the paper coating composition contains a highly branched polyester amide according to formula (1):

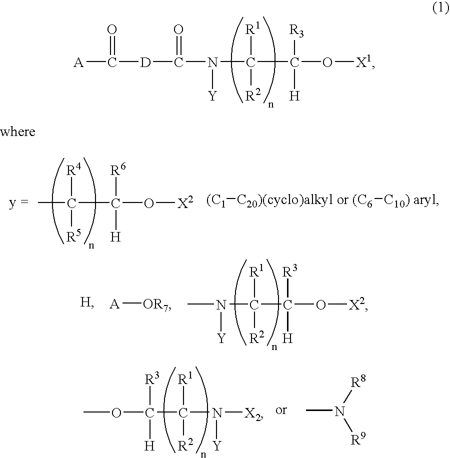

D=(C₂-C₂₄) aryl or (cyclo)alkyl aliphatic biradical, substituted or non-substituted,

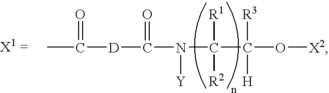

where

X² is at least one time X¹ and ends with

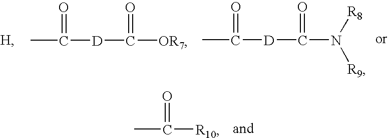

R¹, R², R³, R⁴, R⁵ and R⁶ can, independently from one another, be chosen from H, (C₆-C₁₀) aryl or (C₁-C₈)(cyclo)alkyl radical and n=14, OR₇ is derived from a hydroxy functional monomer, oligomer or polymer, where R⁷ may be H, aryl, alkyl, cycloalkyl or the radical of polyethylene oxide, polypropylene oxide, polytetrahydrofuran or a nylon oligomer, R⁸ and R⁹ can, independently from one another, be chosen from the group of (C₆-C₁₀) aryl groups, whether or not substituted with heteroatoms, or (C₁-C₂₈) alkyl groups, whether or not substituted with heteroatoms and C(O)R₁₀ is derived from a monomer, oligomer or polymer monofunctional carboxylic acid. Preferably n=1, since esterification proceeds fastest when n=1.

The preparation of the hybranes takes place in a known manner, as described in WO-A-99/16810, WO-A-00/58388 and WO-A-00/56804. These publications describe that Hybranes are prepared by reacting a cyclic anhydride or a dicarboxylic acid with an alkanol amine, preferably a di(alkanol) amine. Another method for the preparation of a hybrane is by:

a) contacting a hydroxy or amine functional monomer, oligomer or polymer with a first molar excess of a cyclic carboxylic anhydride, so that a mixture of an acid functional ester, respectively an acid functional amide, and cyclic carboxylic anhydride is formed.

b) contacting the mixture with an amount of alkanol amine, the amount being a second molar excess relative to the first molar excess.

Suitable dicarboxylic acids for the preparation of highly branched polyester amides are dicarboxy acids derived from C₂-C₂₄ (cyclo)alkyl, aryl or (cyclo)alkyl-aryl radicals.

The dicarboxylic acids may be saturated or unsaturated. Examples of dicarboxylic acids are phthalic acid, tetrahydrophthalic acid, naphthalene dicarboxylic acid, hexahydrophthalic acid, succinic acid or glutaric acid.

Suitable cyclic anhydrides are phthalic anhydride, tetrahydrophthalic anhydride, maleic anhydride, (methyl) succinic anhydride and glutaric anhydride.

The alkanol amines are preferably di(alkanol)amines, more preferably a di-β-alkanol amine. Examples are diisobutanol amine and diisopropanol amine.

An advantage of the composition according to the invention is that the composition also has good water retention. This makes it possible for the composition according to the invention to have a higher solid content than the known compositions, which prevents pigment strike-through in the paper and leads to a higher opacity.

Water retention is a measure of a composition's capacity to keep water in contact with pigment and binder. If the rate at which the water from the composition is absorbed by the paper is too high, problems are encountered when the composition is applied, such as for example binder migration, pigment strike-through, reduced gloss and opacity, and higher ink penetration.

A further advantage of the composition according to the invention is that the composition is suitable for activation of optical whiteners.

Yet another advantage of the composition according to the invention is that it permits of a higher solid content, without the viscosity increasing so that the composition can no long r effectively be applied to paper.

Another advantage of the composition according to the invention is that the rate at which the composition can be applied to paper can be increased.

A next advantage of the invention relates to coating compositions that also contain an ammonium salt. A drawback of known compositions containing ammonium salt is that they are often perceived to give off a penetrating ammonia odour. It has been found that an ammonia salt containing composition according to the invention is perceived to give off no or less ammonia odour.

A next advantage of the composition according to the invention is that Hybranes can readily be modified, so that the properties of the composition can simply be varied. One way of increasing the hydrophobic character of the composition is by partially esterifying the hydroxyl groups of the Hybrane with C₂-C₂₂ carboxylic acids. Preferably C₆-C₁₆ carboxylic acids are used for this. A second way of increasing the hydrophobic character is by varying the cyclic anhydrides used in the preparation of the Hybranes. Partial substitution of succinic anhydride by hexahydrophthalic anhydride, phthalic anhydride or an alkenyl succinic anhydride in a Hybrane based entirely on succinic anhydride, for example, results in a strong increase in the hydrophobic character. The two ways of increasing the hydrophobic character can also be combined.

The choice of the cyclic anhydrides and the substituents also influences the water solubility, the emulsifiability and the dispersibility, the film-forming properties, the surface tension and the rheological properties of the composition and the paper coating made of it.

The composition according to the invention contains between 0.01 and 100 wt. % of a highly branched polyester amide. At amounts lower than 0.01 wt. % the viscosity reduction is negligible. Preferably the paper-printing composition according to the invention contains between 0.01 and 50 wt. % of the highly branched polyester amide. It has been found that compositions with more than 50 wt. % polyester amide have a certain tackiness.

Where this invention gives weight percentages, these are weight percentages relative to the total solid content of the paper coating composition, unless explicitly stated otherwise.

Various types of pap r coating compositions are known, such as sizing compositions, coating compositions and ink jet coating compositions.

In the context of this application a sizing composition is understood to be a composition containing more than 80 wt. % starch and a relatively small amount of polymer, for example less than 15 wt. %.

Preferably a sizing composition according to the invention contains between 4 and 6 wt. % Hybrane.

A coating composition is understood to be a composition containing between 1 and 99 wt. % pigment. Such a composition generally contains binders that keep the pigments together and are responsible for the adhesion to the paper. Preferably the composition according to the invention contains between 70 and 90 wt. % pigment. The viscosity reducing effect of Hybranes is highest in particular in the area of the high pigment contents. A coating composition preferably contains between 0.2 and 1.0 wt. % Hybrane, more preferably between 0.2 and 0.4 wt. % Hybrane.

Starch is often used as binder as it is cheaper than SBR co- or terpolymers. However, a drawback of starch-is that it displays a strongly dilatant behaviour. This means that the viscosity increases at high shear rates. This limits the rate at which the paper coating composition can be applied. Surprisingly, it has now been found that the presence of a Hybrane in the coating composition according to the invention not only reduces the viscosity in an absolute sense, but also reduces the dilatant behaviour of compositions containing starch.

An ink jet coating composition is understood to be a paper coating composition that contains more than 15 wt. % of a polymer. Examples of polymers used in known compositions for ink jet coatings are polyvinyl pyrrolidone (PVP), SBR, starch, polyvinyl alcohol and combinations of these. Mass average molar masses used for these known compositions are generally higher than 600,000 g/mol. A drawback of the known compositions is that these compositions exhibit dilatant behaviour. As a result, coating of paper with these compositions is limited to speeds of at most 200-300 m/min. The advantage of the use of a Hybrane as replacement for the known polymers in an ink jet coating composition is that it permits of coating rates of more than 1000 m/min to be reached. A further advantage of the ink jet coating composition according to the invention is that it dries quickly, is tack-free at a Hybrane content of less than 50 wt. %, permits of a higher solid contents and does not display any yellowing.

There is no fixed basic composition for paper coating compositions. Components that are often used in paper coating compositions besides pigments and binders are starch, dispersion agents, xtenders for optical whiteners, defoaming agents, de-aerating agents, colourants, biocides, agents that increase the hydrophobic character and agents that influence the rheological properties of a composition.

Examples of pigments that are often used are calcium carbonate, talc, kaolin, bentonite and titanium dioxide.

For binders use is often made of natural polymers such as starch or soybean meal proteins or use may be made of a synthetic polymer. As synthetic polymer use is made of styrene-butadiene (SBR) co- or terpolymer, versatates, styrene acrylates and vinyl acetate. Use is also made of mixtures of two or more binders.

Examples of starch types that are often used are potato starch, maize starch and wheat starch.

Dispersion agents that are often used are for example soaps and polyacrylic acid derivatives.

Agents often used to increase the hydrophobicity are for example stearates, alkenyl dimers, alkenyl succinic anhydride and waxes.

Examples of agents often used to influence the rheological properties are soy protein, starch, carboxymethyl cellulose, acrylic acid and polyacrylates.

The pH of the paper coating composition may vary, but as a rule the composition is basic. Preferably the pH of the composition according to the invention lies between 7 and 10.

The solid content of the composition according to the invention may vary between wide limits, for example between 1 and 75 wt. % relative to the weight of solid and water.

Preferably a sizing composition according to the invention has a solid content of between 6 and 10 wt. %, a coating composition according to the invention between 35 and 70 wt. %, and an ink jet coating composition between 15 and 60 wt. %, all weight percentages being taken relative to the weight of solid and water.

The preparation of the composition according to the invention takes place in the customary manner, as for example described in “Essential Guide to Aqueous Coatings of Papers and Board” by T. W. R. Dean Ed. PITA, Bury, 1997 (ISDN 9530227-0-6). The ord r in which the components are added to one another is not critical. Thus, for example, the Hybrane may be added to a paper coating composition both before and after the pigment. Preferably the Hybrane is added shortly after the pigment.

A preferred composition is characterized in that the composition according to the invention also contains a polymer that contains monomer units of styrene and maleic anhydride (SMA) or a derivative of said polymer. A derivative is also understood to include a salt. This ensures that the composition according to the invention has a low viscosity and yet forms strong and flexible films. Further it ensures that a paper coating prepared using the preferred composition permits of printing resolutions of at least 360 DPI and moreover offers excellent colour reproduction, with the coloured ink being fixed associatively, in particular with the colours magenta, yellow, green and black. Other advantages of the SMA containing composition according to the invention are better film formation, water retention and adhesion to paper as well as a shorter drying time. In addition, the ink holdout and coating holdout are also strongly improved.

The mass average molar mass of the SMA polymer may vary within wide limits, for example between 3000 and 400,000 g/mol. Preferably the composition according to the invention contains SMA having a molar mass between 30,000 and 150,000 g/mol. The ratio between the styrene monomer units and the maleic anhydride monomer units, too, may vary within wide limits, for example between 0.1:1 and 15:1. Preferably the composition according to the invention contains SMA in which the ratio between the styrene monomer units and the maleic anhydride monomer units lies between 2.5:1 and 3:1.

The ratio between the amount of Hybrane and the amount of SMA, and the composition of, respectively, the polyester amide and the SMA polymer, have a major influence on the hydrophobic character of the composition according to the invention.

A paper coating composition suitable for application to paper by means of a high-speed pre-coating process preferably contains 0.1-0.3 wt. % Hybrane and 0.1-0.3 wt. % SMA derivative. As SMA derivative use can for example be made of PRETOP 85 from TOPCHIM.

The invention also relates to a process for the preparation of the SMA containing composition according to the invention. It has been found that the above-mentioned advantages of this composition are achieved in particular by heating an aqueous solution of SMA or an SMA derivative to at least 50° C.

Special preference is given to a composition according to the invention that also contains between 10 and 80 wt. % of an acrylate emulsion. This ensures that the coating prepared with such a composition has a strongly improved hydrophobic character.

The invention also relates to a gas tight, halogen free repulpable coating.

In known gas tight coatings paper is generally coated with a halogen containing coating. The disadvantage of such gas tight coated paper is that it cannot be reprocessed due to the presence of halogen containing compounds.

For the preparation of a gas tight repulpable coating, compositions with a highly branched polyester amide content of between 50 wt. % and 100 wt. % are preferred, more preferably such a composition also contains between 1 and 50 wt. % of hydrophobicity imparting agents. Examples of hydrophobicity imparting agents are waxes and paraffins.

The advantage of paper coated with such an aqueous composition according to the invention is that it can be used to obtain a gas tight, halogen-free repulpable coating.

The invention also relates to paper coated with an aqueous composition according to the invention.

### EXAMPLES AND COMPARATIVE EXPERIMENTS

### Example 1

Hybranes were prepared using the method described in WO-A-99/16810, WO-A-00/68388 and WO-A-00/56804. The types and amounts of the constituent components were varied. The molar ratios of the compounds from which the Hybranes are formed are given in Table 1. These ratios also determine, through the stoichiometry, the number average molar mass of the resulting Hybrane.

Coating compositions were prepared according to the method indicated in ISDN 9530227-0-6. The basic composition is given in Table 2. In all formulations 0.2 wt. % Hybrane was added. The viscosities of these compositions were measured with an ACAV A2 high-shear viscosimeter of Fintech. The results are presented in FIG. 1, in which the series numbers (2-6) correspond to the numbers in the last column of Table 1.

### Comparative Experiment 1

Use was made of a composition as in Table 2, in which Hybrane had been replaced with 11.2 g wet (2.8 g dry) pyrrolidone with a k value of 30,000. The viscosity measured is included in FIG. 1 as “Series 1”.

TABLE 1

| | DiPA | SAnh | HHAnh | PAnh | DSAnh | LA | BA | Series |
|---|---|---|---|---|---|---|---|---|
| S1200 | 1 | 0.83 | | | | | | |
| SB1210 | 1 | 0.84 | | | | | 0.13 | 2 |
| H/S801700 | 1 | 0.7 | 0.18 | | | | | 3 |
| S/D101200 | 1 | 0.75 | | | 0.08 | | | 4 |
| P/S801200 | 1 | 0.67 | | 0.17 | | | | 5 |
| SL1520 | 1 | 0.83 | | | | 0.27 | | 6 |

DiPA = diisopropanolamine;
SAnh = succinic anhydride;
HHAnh = hexahydrophthalic anhydride;
PAnh = phthalic anhydride;
DSAnh = dodecyl succinic anhydride;
LA = lauric acid;
BA = benzoic acid

TABLE 2

| Raw materials | Wet weight (g) | Dry weight (g) |
|---|---|---|
| 1 H2O | 52.50 | 0.00 |
| CaCO3 Carbital 95 | 718.30 | 560.27 |
| Amazone 88 (Kaolin) | 324.50 | 240.13 |
| Delfoam defoaming agent | 0.33 | 0.33 |
| Dispersion agent-GXL | 2.40 | 0.82 |
| IB blue colourant | 0.02 | 0.02 |
| IV violet colourant | 0.10 | 0.10 |
| PVAL Mowiol 4/88 | 23.7 | 3.80 |
| NaOH 30% | 0.03 | 0.01 |
| Latex SBR SB 489 N | 168.00 | 84.00 |
| Tinopal OB | 7.60 | 7.60 |
| Primal polyacrylate | 1.33 | 0.40 |
| thickener | | |

From the results presented in FIG. 1 for a wide range of shear rates it is evident that the compositions according to the invention have a low viscosity compared with the known composition.

[image]

### Example 2

To show the influence of Hybrane on a starch containing aqueous coating composition, an aqueous composition according to the invention with a Hybrane (S1200, for composition see Table 1) and a composition without Hybrane (Comparative Experiment 2) according to the composition in Table 3 were prepared. The solid content in both cases was 69 wt. % relative to the total amount of solid and water.

TABLE 3

| | Weight (g) | Weight (g) |
|---|---|---|
| Raw materials | Example 2 2 | Comp. Exp. 2 2 |
| CaCO3 | 75 | 75 |
| Kaolin | 25 | 25 |
| PVAL Mowiol 4/88 | 0.5 | 0.5 |
| potato starch | 5 | 5 |
| Latex SBR SB 489 N | 7 | 7 |
| Tinopal OB | 0.5 | 0.5 |
| Primal polyacrylate thickener | 0.1 | 0.1 |
| Topbrane 125-S1200 | 0.4 | 0.0 |

The shear rates measured with an ACAV A2 high shear viscosimeter are presented in Table 4 and are plotted in FIG. 2.

TABLE 4

| | Shear rate | Visc. |
|---|---|---|
| | (10\hat{ }6)1/s) | mPas |
| Series 1 (Comp. Exp.) | 8.44 | 102.4 |
| | 7.81 | 94.8 |
| | 6.92 | 89 |
| | 6.03 | 81.5 |
| | 4.94 | 74.4 |
| | 3.74 | 65.2 |
| | 2.26 | 52.8 |
| Series 2 (S1200) | 17.1 | 50.1 |
| | 14.68 | 50 |
| | 12.76 | 47.9 |
| | 10.19 | 48 |
| | 7.9 | 46.2 |
| | 5.74 | 42.1 |
| | 3.23 | 37 |

[image]

This clearly shows the viscosity reducing effect of Hybrane in the area of high shear rates in a starch containing coating composition.

### Comparative Experiment 3

The components listed in Table 5 are added, in the same sequence as in the table, to a stirred mixture of water and pigments (CaCO3 and kaolin). The resulting composition is an example of a known topcoat formulation.

TABLE 5

| | Weight | Weight |
|---|---|---|
| Raw materials | wet | dry |
| 1 H2O | 52.50 | 0.00 |
| CaCO3 Carbital 95 | 718.30 | 560.27 |
| Amazone 88 (Kaolin) | 324.50 | 240.13 |
| Delfoam defoaming agent | 0.33 | 0.33 |
| Dispersion agent-GXL | 2.40 | 0.82 |
| IB blue colourant | 0.02 | 0.02 |
| IV violet colourant | 0.10 | 0.10 |
| PVAL Mowiol 4/88 | 34.20 | 5.47 |
| NaOH 30% | 0.03 | 0.01 |
| Latex SBR SB 489 N | 168.00 | 84.00 |
| PRETOP 702 | 11.20 | 2.80 |
| Tinopal OB | 7.60 | 7.60 |
| Primal polyacrylate thickener | 1.33 | 0.40 |

### Comparative Experiment 4. Composition with SMA

In this Comparative Experiment an SMA derivative was added to the composition of Comparative Experiment 3. The composition is given in Table 6.

TABLE 6

| | Weight | Weight |
|---|---|---|
| Raw materials | wet (g) | dry (g) |
| CaCO3 Carbital 95 | 718.30 | 560.27 |
| Amazone 88 (Kaolin) | 324.50 | 240.13 |
| Delfoam defoaming agent | 0.33 | 0.33 |
| Dispersion agent-GXL | 2.40 | 0.82 |
| IB blue colourant | 0.02 | 0.02 |
| IV violet colourant | 0.10 | 0.10 |
| NaOH 30% | 0.00 | 0.00 |
| Latex SBR SB 489 N | 168.00 | 84.00 |
| PRETOP 702 | 11.20 | 2.80 |
| Tinopal OB optical white | 7.60 | 7.60 |
| Primal polyacrylate thickener | 1.33 | 0.40 |
| SMA derivative | 12.42 | 2.36 |

### Example 3

### Composition with Hybrane and SMA

This example demonstrates the influence of a 1:1 mixture of Hybrane S1520 (for its composition see Table 1) with an SMA derivative based on a copolymer with a molar weight of 125,000 g/mol and a styrene: maleic anhydride ratio of 3:1 (Topbrane 125-SL152) on the viscosity under shear of a top coat composition. The composition is given in Table 7. Even though the Brookfield viscosity of the composition according to the invention is higher than that of the composition containing exclusively SMA, the viscosity at a high shear rate is substantially lower than that in Comparative Experiments 3 and 4, in which no Hybrane was applied (see Table 8).

This viscosity improvement was achieved in spite of the increase in the solid concentration of the formulation. In addition, the surface of test paper coated with this composition has an improved contact angle compared with the known compositions.

TABLE 7

| | Weight | Weight |
|---|---|---|
| Raw materials | wet | dry |
| H2O | 19.00 | 0.00 |
| CaCO3 Carbital 95 | 718.30 | 560.27 |
| Amazone 88 (Kaolin) | 324.50 | 240.13 |
| Delfoam defoaming agent | 0.33 | 0.33 |
| Dispersion agent-GXL | 2.40 | 0.82 |
| IB blue colourant | 0.02 | 0.02 |
| IV violet colourant | 0.10 | 0.10 |
| PVAL Mowiol 4/88 | 00.00 | 00.00 |
| NaOH 30% | 0.03 | 0.01 |
| Latex SBR SB 489 N | 168.00 | 84.00 |
| PRETOP 702 | 11.20 | 2.80 |
| Tinopal OB | 7.60 | 7.60 |
| Primal polyacrylate thickener | 1.33 | 0.40 |
| Topbrane 125-SL1520 | 19.72 | 3.8 |
| TOTAL | 1299.36 | 905.41 |

TABLE 8

| | Viscosity | | Max. | Viscosity | Contact |
|---|---|---|---|---|---|
| | Brookfield | | shear | MPa · | angles |
| Topcoat | 100 t/min | Solid | rate 1/s | sec | 3 sec |
| Comp. | 950 mPa/sec | 68.3% | 795,000 | 108.5 | 67°-65° |
| Exp. 3 | | | | | |
| Comp. | 720 mPa/sec | 69.3% | 974,000 | 88.4 | 68°-68° |
| Exp. 4 | | | | | |
| Example 3 | 780 mPa/sec | 69.7% | 1,213,000 | 71.0 | 77°-74.5° |

1. Aqueous paper coating composition, containing water and a solid with a solid content of between 1 and 75 wt. % relative to the weight of water and solid, characterized in that the composition contains between 0.01 and 100 wt. % (relative to the solid weight) of a highly branched polyester amide.

2. Composition according to claim 1, the composition containing between 0.01 and 50 wt. % of a highly branched polyester amide.

3. Composition according to either of claims 1-2, the polyester amide having a number average molar weight of at least 800 g/mol.

4. Composition according to any one of claims 1-3, which contains between 1 and 99 wt. % pigment.

5. Composition according to claim 4, which composition also contains between 70 and 99 wt. % pigment.

6. Composition according to any one of claims 1-3, the composition containing between 0.01 and 15 wt. % of a highly branched polyester amide and the composition also containing starch.

7. Composition according to any one of claims 1-6, the composition also containing SMA or an SMA derivative.

8. Composition according to claim 6, obtainable by heating the highly branched polyester amide in the presence of SMA or an SMA derivative.

9. Composition according to any one of claims 1-8, characterized in that the composition also contains an acrylate emulsion.

10. Process for the preparation of a composition according to claim 7 or 8, characterized in that an aqueous solution of SMA and a highly branched polyester amide is heated to at least 50° C.

11. Paper coated with a composition according to any one of claims 1-9.

12 Use of a composition according to any one of claims 1-5 for improvement of the printability of paper.

13. Use of a composition according to claim 1, the composition containing between 50 and 100 wt. % of a highly branched polyester amide for the preparation of gas tight repulpable paper or cardboard.
